(19) United States
(12) Patent Application Publication
(10) Pub. No.: US 2015/0252154 A1
(43) Pub. Date: Sep. 10, 2015

(54) METHOD FOR MANUFACTURING AN ELEMENT OF THERMOPLASTIC COMPOSITE MATERIAL AND AN ELEMENT OF THERMOPLASTIC COMPOSITE MATERIAL OBTAINED THEREWITH

(71) Applicant: TEN CATE ADVANCED COMPOSITES B.V., Nijverdal (NL)

(72) Inventors: Robertus Gerardus Lenferink, Tubbergen (NL); Roger De Leeuw, Almelo (NL)

(21) Appl. No.: 14/408,173

(22) PCT Filed: Jun. 17, 2013
(86) PCT No.: PCT/NL2013/050428

§ 371 Date: Dec. 15, 2014

(30) Foreign Application Priority Data
Jun. 15, 2012 (NL) 2009016

(51) Int. Cl. C08J 5/18; B29C 43/00; C08J 5/04

(52) U.S. Cl. CPC C08J 5/18; C08J 5/042; C08J 5/043; B29C 43/003; C08J 2379/08; B29K 2071/00

(57) ABSTRACT

The invention relates to a method for manufacturing an element of thermoplastic composite material, for instance a plate or sheet, comprising the following steps, to be performed in suitable sequence, of: a) providing a web; b) dissolving a thermoplastic in a solvent; c) arranging the solvent with plastic dissolved therein on the web; d) pressing the solvent with plastic dissolved therein into the web; e) heating the web for the purpose of evaporating the solvent, wherein the plastic remains behind in the web; and f) allowing the web to cool and thus allowing the plastic to cure so as to obtain the element. The invention also relates to an element of thermoplastic composite material obtained by applying the method according to the invention, which element comprises a thermoplastic, for instance plate-like or sheet-like body in which the web is embedded as reinforcement.

The invention relates to a method for manufacturing an element of thermoplastic composite material, for instance a plate or sheet.

The manufacture of an element of thermoplastic composite material can take place using different, per se known methods. A thermoplastic can be arranged in different ways here in a web in order to obtain a plastic element in which the web is embedded as reinforcement. The currently known methods each have their own specific drawbacks however, such as the high cost of for instance fine grinding of the thermoplastic or being able to arrange the thermoplastic only with difficulty in the web.

It is an object of the invention to at least partially obviate the above stated drawbacks. It is a particular object of the invention to provide an alternative method with which an element of thermoplastic composite material can be manufactured in simple and/or relatively inexpensive and/or rapid manner.

The method of the type stated in the preamble comprises for this purpose according to the invention the following steps, to be performed in suitable sequence, of:

a) providing a web;

b) dissolving a thermoplastic in a solvent;

c) arranging the solvent with plastic dissolved therein on the web;

d) pressing the solvent with plastic dissolved therein into the web;

e) heating the web for the purpose of evaporating the solvent, wherein the plastic remains behind in the web; and

f) allowing the web to cool and thus allowing the plastic to cure so as to obtain the element.

Because the thermoplastic is dissolved in the solvent according to the invention, it is not necessary for the plastic to be ground fine, whereby costs can be saved.

The mixture of thermoplastic and solvent has a lower viscosity than a non-dissolved melted plastic, whereby the mixture can flow easily between separate filaments of the web and arranging of the plastic in the web can take place in simple manner.

Step c) can for instance take place by drawing the web through a bath filled with solvent having plastic dissolved therein. This web drawn through the bath can subsequently be pulled in step d) through two pressure rollers disposed close to each other for the purpose of pressing the solvent with plastic dissolved therein into the web. The two pressure rollers are disposed here at a predetermined distance from each other so that the web with solvent and plastic dissolved therein will have a predetermined thickness.

Step e) can for instance take place by heating the web with solvent and plastic dissolved therein in an oven. After or during cooling and curing of the web with plastic, the web with plastic can be rolled onto a roll to enable easy storage and transport of the composite element.

The web can be any random web such as, though not exclusively, a non-woven, a fabric, a sheet or the like.

It will therefore be apparent that the term web should not be interpreted here as being limited to a non-crimp fabric (NCF), even though the web can indeed be such in an embodiment of the method according to the invention. Web is understood here to mean any random web or material such as, though not exclusively, a non-woven, a fabric, a sheet or the like.

An embodiment of the method according to the invention further comprises the step, to be performed after step e), of:

g) pressing the web with plastic or the element at increased temperature in order to flatten the web with plastic or the element.

A composite element with a flat surface is hereby obtained in simple manner.

The thickness of the web or element can also be set by performing step g).

The increased temperature preferably lies around or above the softening temperature of the plastic. It is however also possible to perform step g) at a temperature below the softening temperature. The maximum temperature for performing step g) is the temperature at which degradation of the plastic which is still acceptable takes place. Increased temperature is therefore understood here to mean a temperature suitable for performing step g), in particular a temperature lying a maximum of 70° C. below the softening temperature of the chosen plastic up to a maximum of the (acceptable) degradation temperature of the chosen plastic. For a large number of suitable plastics the increased temperature lies in practical manner between about 140° C. and 360° C.

The web with plastic can for instance be pressed immediately following step e), when it is still warm, wherein step f) takes place after step g) so that it is not necessary to heat the web twice.

Alternatively, step g) can take place before step f), wherein the element is heated again. This is advantageous for instance when a number of elements obtained in step f) are pressed together in order to obtain a stiff composite plate.

The web can be any random web. The web particularly comprises mutually connected fibres. The fibres can for instance be mutually connected by interweaving, adhesion or stitching.

The fibres are preferably chosen from the group comprising glass fibre, aramid fibre, carbon fibre and polyester fibre. Such fibres impart a strong reinforcement to the plastic.

In order to obtain a composite element which is strong and/or stiff in one direction and for instance resilient in other directions, the fibres in the web can extend in one direction. Such a web is also referred to as a unidirectional fibre.

The web can also comprise a number of layers, in each of which the fibres extend in one direction and wherein the fibres of the different layers extend in different directions. A stiff composite element is hereby obtained which has a relatively low weight. The fibres of the different layers can for instance be arranged at an angle of 45° to each other, wherein four layers are arranged on each other to obtain a composite element which is equally stiff and/or strong in substantially all directions. The directions of the fibres can be chosen subject to the desired load on the composite element.

It is noted that it may be the case that one layer at a time of the number of layers is formed with the method according to the invention, these layers being pressed together at increased temperature so as to obtain the composite element. An increased quality of the impregnated web or element can be obtained by pressing the plastic per layer into the web. It may alternatively be the case that the web of step a) has the number of layers. An advantage of a web having the number of layers in step a) is that there is a relatively small chance of for instance breakage or splitting of the web during manufacture of the composite element. It is an advantage of the method according to the invention that a web with such a number of layers, which is therefore relatively thick, can be easily and/or properly impregnated with the plastic.

The web with fibres extending in one direction or the web with the number of layers as described above both have the advantage that no crimp occurs. Such webs are also referred to as non-crimp fabrics. Because of their properties, composite elements comprising such non-crimp fabrics are suitable for diverse applications.

The plastic is preferably chosen from the group comprising polyetherimide (PEI), polyethersulfone (PESU), polycarbonate (PC), polyether ether ketone (PEEK), polyester/polyethylene terephthalate (PET) and mixtures thereof.

Particularly a combination of a non-crimp fabric and polyetherimide (PEI) produces a composite element which, because of its properties, is suitable for diverse high-grade purposes. Such a composite element is for instance suitable for manufacturing components of vehicles such as cars, trucks, boats, aircraft, helicopters and space vehicles.

Particularly a combination of a non-crimp fabric comprising glass fibre or carbon fibre with PEI produces a composite material having high temperature resistance, low flammability, good impact resistance and low moisture absorption.

The solvent is preferably chosen from the group comprising n-methyl-2-pyrrolidone (NMP) and dimethylacetamide (DMAC).

Such solvents are relatively inexpensive and/or less harmful to the environment or people compared to other known solvents.

In an embodiment of the method according to the invention the quantity of solvent in the mixture of solvent with plastic dissolved therein amounts to a minimum of 50% by volume, a minimum of 55% by volume, a minimum of 60% by volume, a minimum of 65% by volume, a minimum of 70% by volume, a minimum of 75% by volume or a minimum of 80% by volume.

With such a minimum volume of solvent a good impregnation of the web can be provided, since at such a minimum volume of solvent the viscosity of the mixture of solvent and plastic dissolved therein is sufficiently low so that the mixture can flow relatively well into the web.

A ratio of plastic and solvent of 1 to 2.5 is found to be a particularly good one, this amounting to about 71% by volume of solvent.

Applicant has found that, with a view to the improved impregnation, the quantity of solvent in the mixture can even be chosen such that, after steps c) and d) have been performed, the web can comprise less plastic than is desirable. It can be advantageous for this purpose for the method to comprise the steps of repeating the steps c)-e) after performing the steps c)-e) and prior to step f) or after performing the steps c)-f). Following heating or cooling of the web the solvent with plastic dissolved therein is here once again arranged on the web, wherein the web is then pressed once again, wherein the web is subsequently heated once again and then optionally cools again. Relatively good impregnation of the plastic in the web hereby takes place twice, wherein the final quantity of plastic in the web is as desired. This can increase the quality of the element.

Alternatively, the steps c) and d) can be repeated after performing the steps c) and d) and prior to steps e) and f). The solvent with plastic dissolved therein is arranged once again on the web here following pressing, wherein the web is subsequently pressed once again, wherein the web is then heated and subsequently cools.

The invention further relates to an element of thermoplastic composite material obtained by applying the method according to any of the foregoing claims, which element comprises a thermoplastic, for instance plate-like or sheet-like body in which the web is embedded as reinforcement.

Because of its properties such an element is suitable for diverse purposes such as, though not exclusively, for manufacturing components of vehicles such as cars, trucks, boats, aircraft, helicopters and space vehicles.

According to the invention the element of thermoplastic composite material can be manufactured as described above relatively inexpensively using the method according to the invention when compared to such an element of thermoplastic composite material manufactured by another method. The composite element manufactured with the method according to the invention is hereby suitable for applications in which cost is an important factor.

The element according to the invention can be modelled to any desired form, wherein modelling preferably takes place during heating.

The invention will be further elucidated with reference to figures shown in a drawing, in which:

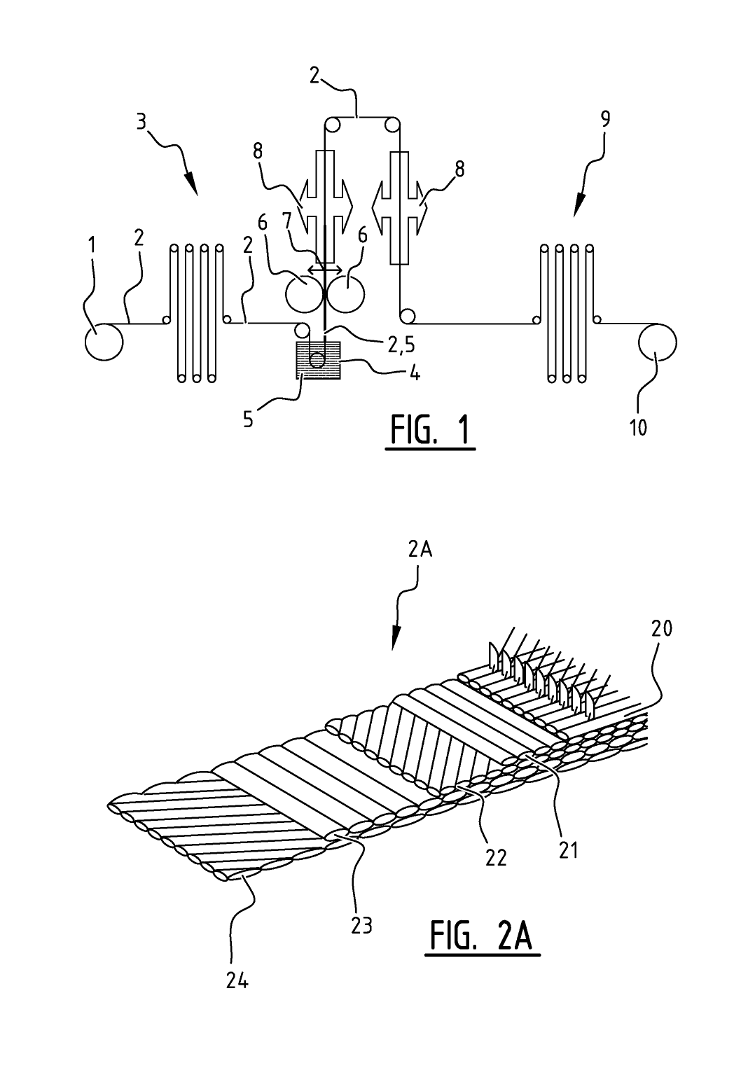

FIG. 1 shows schematically the method according to the invention; and

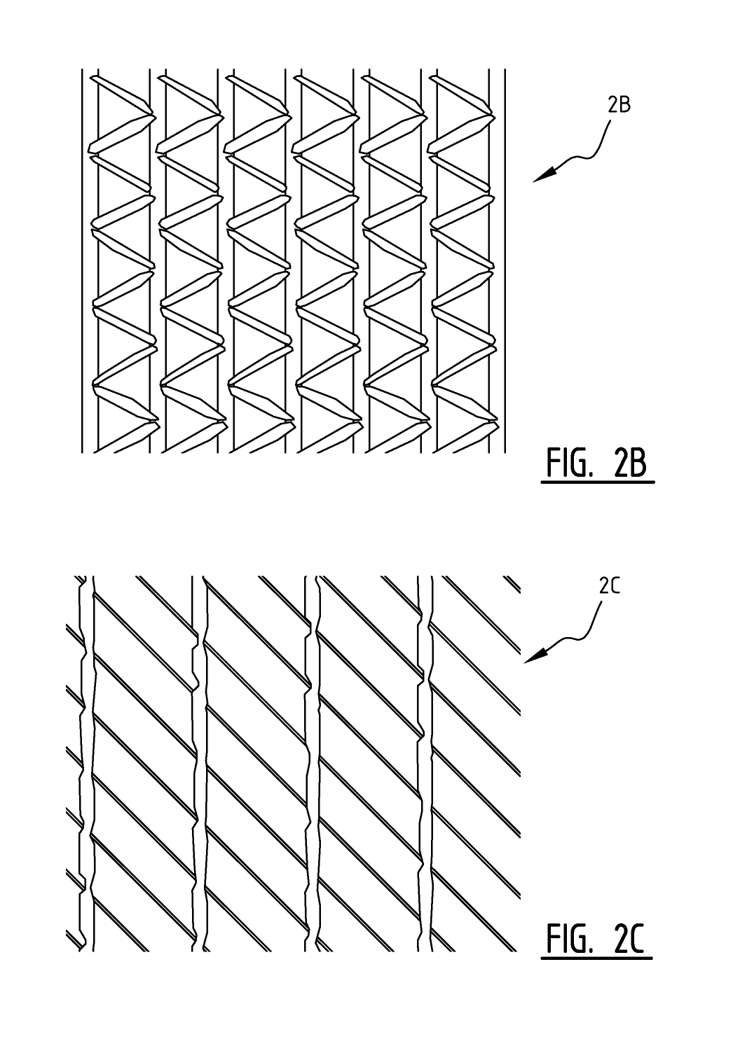

FIGS. 2A-2C each show a web particularly suitable for the method according to the invention.

FIG. 1 shows schematically the steps of the method for manufacturing an element of composite material according to the invention.

Provided in a first step is a web 2 rolled onto a roll 1. Web 2 is a fibre web with mutually connected fibres of glass, aramid, carbon or polyester.

Web 2 is subsequently drawn off the roll 1 and collected in a web buffer 3. Collecting a supply of web 2 enables easy replacement of an empty roll by a fresh roll without the further process having to be halted. The process according to the invention can in this way take place continuously.

In a following step the web 2 is pulled through a bath 4 filled with a mixture 5 of solvent with thermoplastic dissolved therein, for instance by means of pulling rollers, so that the mixture 5 of solvent and plastic adheres to web 2. Dissolving of the plastic in the solvent can for instance take place during heating or stirring, wherein bath 4 is filled with the mixture 5 after dissolving of the plastic in the solvent. The plastic comprises for instance a synthetic resin granulate, which granulate can dissolve easily in the solvent. The solvent is for instance n-methyl-2-pyrrolidone (NMP) and dimethylacetamide (DMAC). The plastic is for instance polyetherimide (PEI), polyethersulfone (PESU), polycarbonate (PC), polyether ether ketone (PEEK), polyester/polyethylene terephthalate (PET) or mixtures thereof.

In a subsequent step the web 2 with the mixture 5 of solvent with plastic dissolved therein is carried through a pinch of two driven pressure rollers 6 disposed adjacently of each other, wherein the mixture 5 is pressed into web 2. The two pressure rollers 6 are disposed here at a predetermined distance 7 from each other so that web 2 with mixture 5 has a predetermined thickness.

The web 2 with the mixture 5 pressed into it is subsequently heated in an oven, wherein the solvent evaporates out of web 2. The evaporation of the solvent is indicated in FIG. 1 with numeral 8.

The combination of web 2 with the plastic is then collected in a second web buffer 9, after which web 2 is arranged on a roll 10. The second web buffer 9 here also provides the advantage that the process according to the invention can take place continuously without this process having to be halted during removal of a full roll 10 and arranging of a new empty roll. Web 2 with the plastic cools in the second web buffer 9 in order to obtain a composite element.

The thus obtained composite element can optionally then be pressed at increased temperature for the purpose of flattening the element, or a number of thus obtained composite elements can be pressed together to obtain a stiff composite element (not shown).

FIGS. 2A-2C each show a non-crimp fabric web 2A-2C. The fibre web 2A of FIG. 2A has four layers 20-24 arranged on each other, wherein the fibres of layers 20-24 extend in different directions. The fibres of the upper layer 20 extend here in the length of fibre web 2A, this direction being defined here as 0°. The fibres of the layer 21 extending immediately below layer 20 extend perpendicularly of the fibres of layer 20, or at an angle of 90°. The fibres of the layer 22 extending immediately below layer 21 extend at an angle of 45° to the fibres of layer 20. The fibres of the layer 23 extending immediately below layer 22 extend in the same direction as the fibres of layer 21, i.e. at an angle of 90° to the fibres of layer 20. The fibres of the lower layer 24 extend at an angle of −45° to the fibres of layer 20. The fibres of fibre web 2A are held together by a stitching thread. The arrangement of fibre layers 20-24 in four different directions (−45°, 0°, 45°, 90°), is also referred to as quadraxial.

It is noted that the directions of the fibres of layers 20-24 can be chosen as desired, for instance subject to the desired load on the composite element. The fibres of all layers 20-24 can for instance be disposed in the lengthwise direction of fibre web 2A, so that a so-called unidirectional non-crimp fabric is obtained.

It is further noted that fibre web 2A can comprise any random number of fibre layers. Fibre web 2 can for instance comprise two layers disposed at respective angles of 0° and ±45°, or 0° and 90°, also referred to as biaxial. Alternatively, fibre web 2A can comprise three layers disposed at respective angles of 0°, ±45° and 90°, also referred to as triaxial.

FIG. 2B shows a fibre web 2B, all layers of which are disposed in one direction, i.e. in the lengthwise direction of fibre web 2B. The different fibre filaments of fibre web 2B are mutually connected by stitching thread.

FIG. 2C shows a fibre web 2C, the outer layer of which is disposed at an angle of 45°.

It is noted that the invention is not limited to the shown embodiments, but also extends to variants within the scope of the appended claims.

1. Method for manufacturing an element of thermoplastic composite material, for instance a plate or sheet, comprising the following steps, to be performed in suitable sequence, of:
a) providing a web;
b) dissolving a thermoplastic in a solvent;
c) arranging the solvent with plastic dissolved therein on the web;
d) pressing the solvent with plastic dissolved therein into the web;
e) heating the web for the purpose of evaporating the solvent, wherein the plastic remains behind in the web; and
f) allowing the web to cool and thus allowing the plastic to cure so as to obtain the element.

2. Method as claimed in claim 1, further comprising the step, to be performed after step e), of:
g) pressing the web with plastic or the element at increased temperature in order to flatten the web with plastic or the element.

3. Method as claimed in claim 1, wherein the web comprises mutually connected fibres.

4. Method as claimed in claim 3, wherein the fibres are chosen from the group comprising glass fibre, aramid fibre, carbon fibre and polyester fibre.

5. Method as claimed in claim 3, wherein the fibres in the web extend in one direction.

6. Method as claimed in claim 3, wherein the web comprises a number of layers, in each of which the fibres extend in one direction and wherein the fibres of the different layers extend in different directions.

7. Method as claimed in claim 1, wherein the plastic is chosen from the group comprising polyetherimide (PEI), polyethersulfone (PESU), polycarbonate (PC), polyether ether ketone (PEEK), polyester/polyethylene terephthalate (PET) and mixtures thereof.

8. Method as claimed in claim 1, wherein the solvent is chosen from the group comprising n-methyl-2-pyrrolidone (NMP) and dimethylacetamide (DMAC).

9. Method as claimed in claim 1, wherein the quantity of solvent in the mixture of solvent with plastic dissolved therein amounts to a minimum of 50% by volume, a minimum of 55% by volume, a minimum of 60% by volume, a minimum of 65% by volume, a minimum of 70% by volume, a minimum of 75% by volume or a minimum of 80% by volume.

10. Method as claimed in claim 1, comprising of repeating the steps c)-e) after performing the steps c)-e) and prior to step f) or after performing the steps c)-f).

11. Method as claimed in claim 1, comprising of repeating the steps c) and d) after performing the steps c) and d) and prior to the steps e) and f).

12. Element of thermoplastic composite material obtained by applying the method as claimed in claim 1, which element comprises a thermoplastic, for instance plate-like or sheet-like body in which the web is embedded as reinforcement.
